(19) United States
(12) Patent Application Publication
(10) Pub. No.: US 2023/0256870 A1
(43) Pub. Date: Aug. 17, 2023

(54) SLIDING RAIL HAVING ENHANCED RIGIDITY MODULUS

(71) Applicant: KEIPER (CHANGSHU) SEATING MECHANISMS CO., LTD, Jiangsu (CN)

(72) Inventors: Haila HU, Jiangsu (CN); Bin HUANG, Jiangsu (CN); Wenjin FU, Jiangsu (CN); Hongbin NI, Jiangsu (CN); Dong LIU, Jiangsu (CN)

(73) Assignee: KEIPER (CHANGSHU) SEATING MECHANISMS CO., LTD., Jiangsu (CN)

(21) Appl. No.: 18/302,758

(22) Filed: Apr. 18, 2023

Related U.S. Application Data
(63) Continuation of application No. PCT/CN2021/110435, filed on Aug. 4, 2021.

(30) Foreign Application Priority Data
Oct. 19, 2020 (CN) 202011117203.0

(51) Int. Cl. B60N 2/07

(52) U.S. Cl. CPC B60N 2/0727; B60N 2/073; B60N 2/0705

(57) ABSTRACT

A sliding rail having an enhanced rigidity modulus including an upper rail assembly, a lower rail assembly, and retainers is provided. The upper rail assembly is slidably arranged in a sliding groove in the lower rail assembly through a pair of retainers. First raised ribs and/or steel ball clamping grooves are arranged at intervals on surfaces of the retainers. A steel ball is mounted in the steel ball clamping groove. A supporting structure extending backwards in a length direction of the retainers is arranged at a rear end of each of the retainers. When the upper rail assembly slides backwards to the farthest stroke, the supporting structure provides longitudinal auxiliary support for a mid-rear section of the upper rail assembly, the supporting structure is in contact with the lower rail assembly, and a gap is reserved between the supporting structure and the upper rail assembly.

### CROSS-REFERENCE TO RELATED APPLICATION

This application is a continuation of international application of PCT application serial no. PCT/CN2021/110435 filed on Aug. 4, 2021, which claims the priority benefit of China application no. 202011117203.0 filed on Oct. 19, 2020. The entirety of each of the above mentioned patent applications is hereby incorporated by reference herein and made a part of this specification.

### BACKGROUND

### Technical Field

The present invention relates to an improvement of a sliding rail assembly for a vehicle, and in particular to a sliding rail having an enhanced rigidity modulus.

### Description of Related Art

To meet the comfortability requirement of passengers, a vehicle seat usually requires angle adjustment and displacement adjustment, and an angle adjuster is generally used during adjustment; and a sliding rail is arranged on the seat to realize displacement adjustment, balls are lined between the seat and the sliding rail to reduce friction, and the balls are arranged in a retainer to prevent scattering.

As shown in FIG. 1 to FIG. 3, they are sliding state diagrams of an existing sliding rail assembly for a vehicle seat: the movement mode of the retainers is rolling; the movement mode of the sliding rail is sliding; the movement stroke of the retainer is half of the movement stroke of the sliding rail; and when an upper rail moves to a rearmost position, a distance between a rear end of the upper rail and a rear end of the retainer becomes larger, so this part of upper rail loses the longitudinal support of a lower rail and is in a suspended state. The gravity center of a normal seat load is at a back position, so this section of upper rail is suspended to affect the whole rigidity of the sliding rail, and is easier to shake during vehicle driving, which will bring poor body feeling, or even some noise.

In some vehicle models, to facilitate the third row of passengers to enter the vehicle, due to the space limitation of the rear seats, the second row of sliding rail only can adopt a short retainer, the rigidity is not ideal.

In addition, one development trend of the sliding rail is lightweight. With the application of high-strength steel, the sliding rail has been able to overcome the strength problem and is made thinner and lighter. However, the subsequence reduction of rigidity has brought difficulties to industrial products, thereby limiting the further lightweight.

### SUMMARY

The present invention provides a novel sliding rail design. A supporting structure is additionally arranged on the basis of the original retainer to provide support for the whole upper rail. In particular, the modal of the sliding rail can be effectively improved under the working condition of bumping and shaking, so that the overall stability of the sliding rail assembly can be improved when the sliding rail assembly slides to a farther stroke, the shaking of the sliding rail assembly during vehicle driving can be reduced, and the rigidity of the lightweight sliding rail can be improved. The specific solutions are as follows:

a sliding rail having an enhanced rigidity modulus includes an upper rail assembly, a lower rail assembly, and retainers, where the upper rail assembly is slidably arranged in a sliding groove in the lower rail assembly through a pair of retainers; first raised ribs and/or steel ball clamping grooves are arranged at intervals on surfaces, in contact with the upper rail assembly and the lower rail assembly, of the retainers; a steel ball is mounted in the steel ball clamping groove;

a supporting structure extending backwards in a length direction of the retainers is arranged at a rear end of each of the retainers; and when the upper rail assembly slides backwards to the farthest stroke, the supporting structure provides longitudinal auxiliary support for a mid-rear section of the upper rail assembly, the supporting structure is in contact with the lower rail assembly, and a gap is reserved between the supporting structure and the upper rail assembly.

Further, a guide bevel edge is arranged at a tail end of the supporting structure:

a sliding rail having an enhanced rigidity modulus includes an upper rail assembly, a lower rail assembly, and retainers, where the upper rail assembly is slidably arranged in a sliding groove in the lower rail assembly through a pair of retainers; first raised ribs and/or steel ball clamping grooves are arranged at intervals on surfaces, in contact with the upper rail assembly and the lower rail assembly, of the retainers; a steel ball is mounted in the steel ball clamping groove;

a supporting structure is fixedly mounted at a rear end in the sliding groove; and when the upper rail assembly slides backwards to the farthest stroke, the supporting structure provides longitudinal auxiliary support for the mid-rear section of the upper rail assembly.

Further, supporting strips located in a length direction of the lower rail assembly are arranged on two sides of the supporting structure; guide bevel edges are arranged at two ends of each of the supporting strips; and retainer stop blocks for limiting the sliding strokes of the retainers are respectively arranged at front and rear ends of the supporting strips.

Further, two supporting strips are fixedly connected through a connecting plate; at least one elastic buckle protruding downwards and in clamping connection with a bottom plate of the sliding groove is arranged on the connecting plate; and/or at least one positioning column protruding downwards and embedded into a positioning hole of the bottom plate of the sliding groove is arranged on the connecting plate.

Further, second raised ribs are arranged at intervals on a surface, in contact with the lower rail assembly, of the supporting structure; and/or

a surface of the supporting structure is spray-coated with a lubricating coating; and/or

surfaces of the retainers are spray-coated with lubricating coatings; and/or

a grease layer is arranged between the supporting structure, and the upper assemblies and lower rail assemblies.

Further, the retainers are made of polyamide-6 materials, and the supporting structure is made of polyformaldehyde resin.

Further, the retainers and the supporting structure are made of polyamide-6 materials.

Further, the supporting structure is filled with metal wires or metal balls.

Further, the lubricating coating is a polytetrafluoroethylene coating.

According to the present invention, one section of extending supporting structure is designed on the original retainer, or a fixed supporting structure is mounted at a rear section of the sliding groove of the lower rail. Support can be provided to the whole upper rail through the extending supporting structure or the fixed supporting structure. In particular, the modal of the sliding rail can be effectively improved under the working conditions of bumping and shaking.

### BRIEF DESCRIPTION OF THE DRAWINGS

In order to describe the technical solutions in the embodiments of the present invention more clearly, the following briefly introduces the accompanying drawings required for describing the embodiments or the prior art. Apparently, the accompanying drawings in the following description show only some embodiments of the present invention, and those of ordinary skill in the art may still derive other drawings from these drawings without any creative efforts.

FIG. 1 shows a state in which a sliding rail is located at a design position, where the sliding rail can move back and forth, and a distance between a retainer and a rear end of an upper rail is A;

FIG. 2 shows a state in which a sliding rail is located at a frontmost position, where a distance between a retainer and a rear end of an upper rail is minimum and is A−;

FIG. 3 shows a state in which a sliding rail is located at a rearmost position, where a distance between a retainer and a rear end of an upper rail is maximum and is A+;

FIG. 4a to FIG. 4b are an exploded view and an assembling completion diagram of a sliding rail assembly in Embodiment 1;

FIG. 4c is a sectional view of a vertical section of a retainer between an upper rail assembly and a lower rail assembly in Embodiment 1;

FIG. 5a to FIG. 5c are schematic diagrams of a sliding stroke of a sliding rail in Embodiment 1;

FIG. 6a and FIG. 6b are schematic diagrams in which an upper assembly and a lower assembly of a retainer are connected together through a middle bending part;

FIG. 6c is a schematic diagram in which a steel ball clamping groove and a reinforcing rib are arranged on a retainer in Embodiment 1, where a supporting structure is arranged at one end of one of retainers;

FIG. 6d and FIG. 6e are schematic diagrams in which an array groove is formed in front and back sides of the supporting structure in Embodiment 1;

FIG. 6f shows that one section of a supporting structure is internally filled with a filled extending section in Embodiment 1;

FIG. 6g and FIG. 6h are schematic diagrams in which the extending section in 6f is internally filled with metal wires or metal balls in Embodiment 1;

FIG. 7a is a schematic diagram in which two middle ends of each retainer are connected together through a straw in Embodiment 1;

FIG. 7b is a partial enlarged diagram of FIG. 7a;

FIG. 8a respectively shows an exploded view of a sliding rail assembly in Embodiment 2;

FIG. 8b and FIG. 8c are sliding schematic diagrams of a sliding rail assembly in Embodiment 2; and

FIG. 8d and FIG. 8f are respectively a stereogram, a side view and a top view of a fixed supporting structure in Embodiment 2.

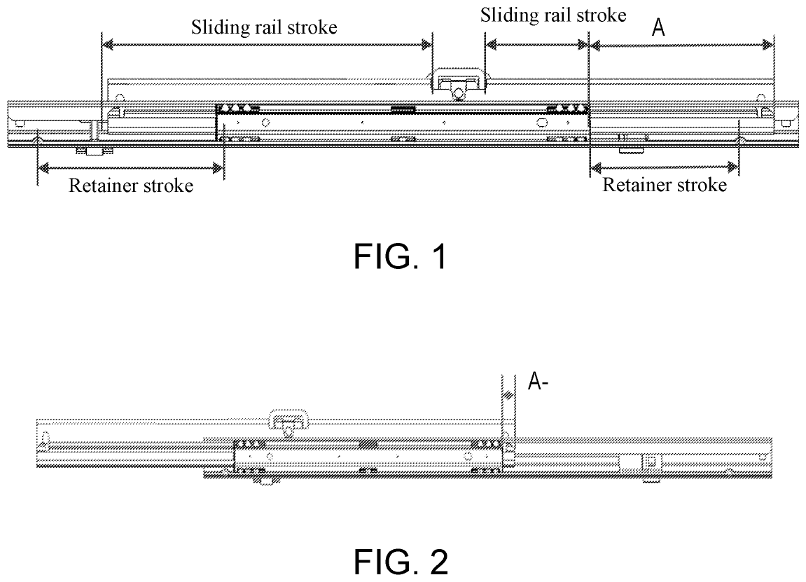

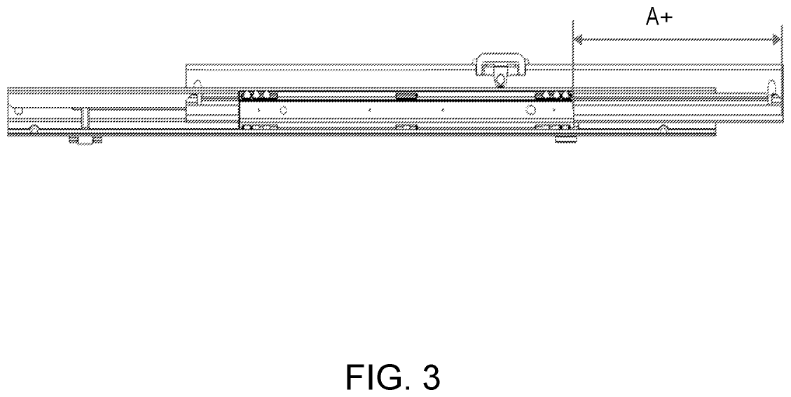

### DESCRIPTION OF THE EMBODIMENTS

In the following description, numerous specific details are given to provide a more thorough understanding of the present invention. However, it will be apparent to those skilled in the art that the present invention may be implemented without one or more of these details. In other examples, to avoid confusion with the present invention, some technical features well known in the art are not described.

To thoroughly understand the present invention, detailed steps and detailed structures will be put forward in the following description so as to explain the technical solutions of the present invention. Preferred embodiments of the present invention are described in detail below; however, in addition to these detailed descriptions, the present invention ma have other embodiments.

### Embodiment 1

For front seats of a vehicle, a sliding rail and a sliding rail stroke are generally long, so a longer retainer 30 can be matched. Due to the length limitation of an upper sliding rail, a length of the retainer 30 will be limited within a certain range. When a long retainer 30 is used, the modal performance of a front end of the sliding rail is generally good, but a mid-rear section of the sliding rail is not supported by the retainer 30, so the problem of poor modal occurs sometimes. If the modal is not up to standard, resonance of parts will be caused, thereby resulting in the problems of abnormal sound and reduced durability.

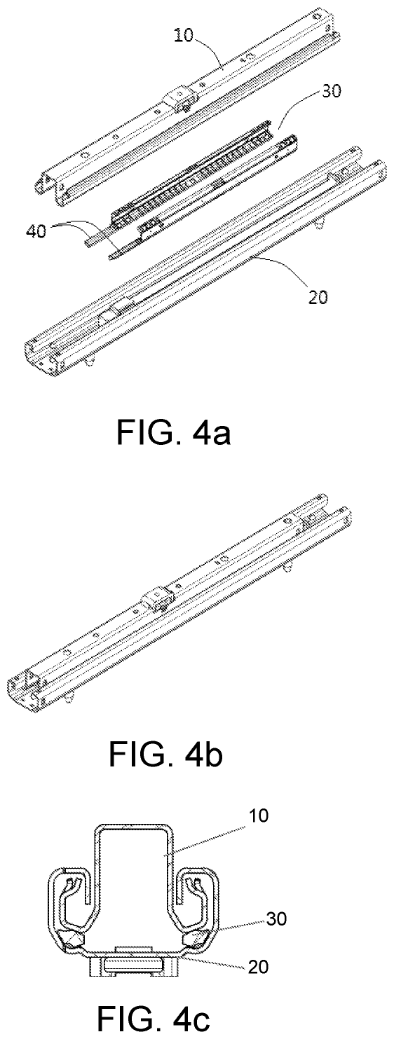

Based on the above reasons, this embodiment designs a sliding type retainer 30 which takes the retainer 30 of the sliding rail of the front seats as a basis and lengthens the lower half section; and when the sliding rail is at a design position, the new retainer 30 provides additional support for the upper rail at the mid-rear section, in particular under the shaking occasion, the modal of the sliding rail can be effectively improved, and the quality of the sliding rail can be improved. Referring to FIG. 4a and FIG. 4b, the specific solution is as follows: the sliding rail includes an upper rail assembly 10, a lower rail assembly 20, and retainers 30. The upper rail assembly 10 is slidably arranged in a sliding groove in the lower rail assembly 20 through a pair of retainers 30. A limiting block for limiting the sliding stroke of the upper rail assembly 10 at a inner rear end in the sliding groove is arranged at the rear end in the sliding groove. First raised ribs and/or steel ball clamping grooves are arranged at intervals on surfaces, in contact with the upper rail assembly 10 and the lower rail assembly 20, of the retainers 30. A steel ball is mounted in the steel ball clamping groove. A supporting structure 40 extending backwards in a length direction of the retainers 30 is arranged at a front end of each of the retainers 30. When the upper rail assembly 10 slides backwards to the farthest stroke, the supporting structure 40 provides auxiliary support for a mid-rear section of the upper rail assembly 10, the supporting structure 40 is in contact with the lower rail assembly 20, and a gap is reserved between the supporting structure 40 and the upper rail assembly 10.

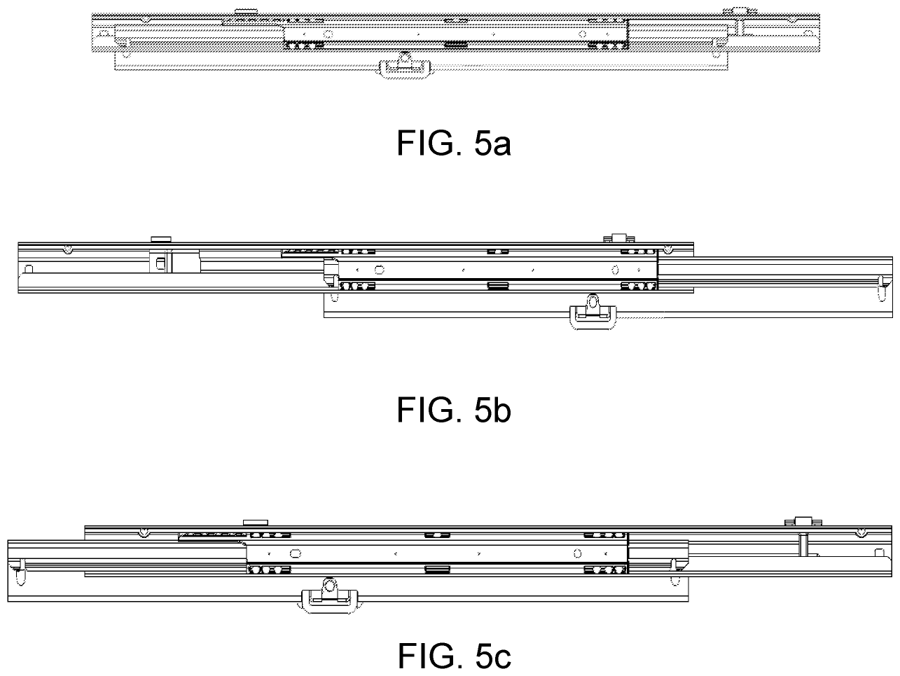

The movement stroke of the retainers 30 is half of the movement stroke of the sliding rail. When the upper rail moves to a frontmost position, due to the limitation of an upper rail rear ball blocking point and a lower rail front ball blocking point, the retainers 30 cannot be entirely lengthened, so the sliding stroke of the retainers 30 is limited. When the upper rail assembly 10 slides backwards to a farther stroke, effective support cannot be provided for the mid-rear section of the upper rail assembly 10. Therefore, according to the present invention, the rear end of the retainer 30 extends backwards to form one section of elastic supporting structure 40. This section of elastic supporting structure 40 can provide longitudinal support for the upper rail assembly 10 sliding to the rear end. In particular, under the shaking occasion, the modal of the sliding rail can be effectively improved, and the quality of the sliding rail can be improved. As shown in FIG. 5a to FIG. 5c, FIG. 5a is a combined diagram of an upper sliding rail and a lower sliding rail in an initial state. During sliding forward, as shown in FIG. 5b, the stability of the upper rail can be ensured due to the action of the retainer at this time. During sliding backward to the farthest stroke, the retainer is limited by the sliding stroke and cannot provide sufficient support for the upper rail. The extending section elastic supporting structure 40 designed by the present invention provides auxiliary support for the rear half section of the upper rail, as shown in FIG. 5c.

FIG. 4a is a schematic diagram of a retainer 30 and a supporting structure 40 at a rear end of the retainer in an optional embodiment. The retainer 30 has the following characteristics:

(1) the body material of the retainer 30 uses a nylon (PA6) material with high elasticity and shock-absorbing property, and the design state facilitates injection molding.

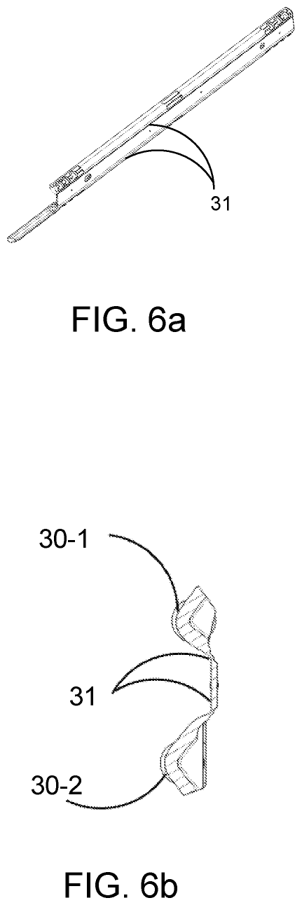

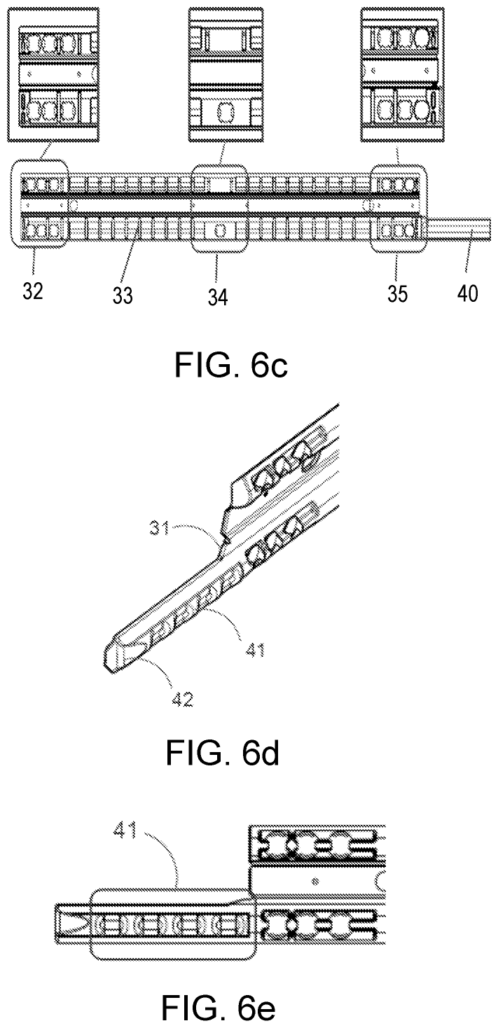

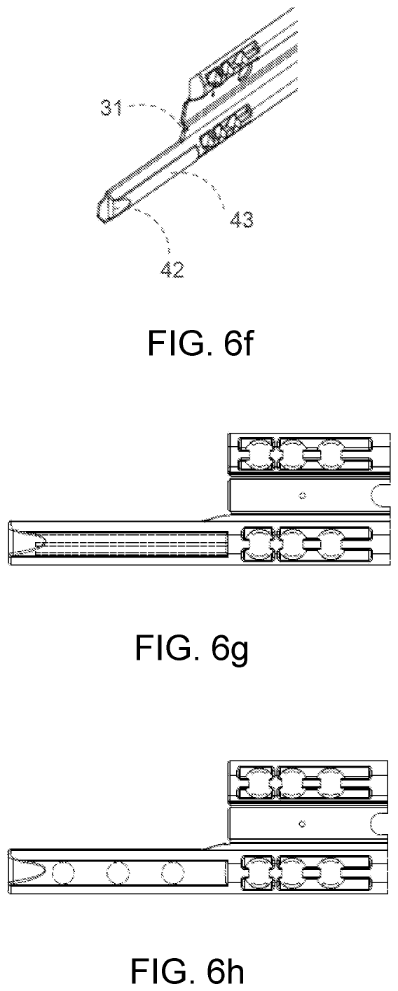

(2) The body of the retainer 30 includes upper and lower assemblies 30-1 and 30-2. The upper and lower assemblies are connected together through a thin bending area 31 facilitating bending, as shown in FIG. 6a and FIG. 6b.

(3) The steel balls are fixed on the retainer 30 through the steel ball clamping grooves 32, 34 and 35 in front and back sides of the retainer 30, and raised ribs are designed on the front and back sides, so that the contact area of the retainer 30 and the sliding rail, and the friction force are reduced, as shown in FIG. 6c.

(4) Array reinforcing ribs 33 are arranged on the front and back sides of the retainer 30, so that the overall strength of the retainer 30 is improved, as shown in FIG. 6c.

In an optional embodiment, to ensure the strength of the supporting structure 40 at the extending section, the material selects POM or other materials with high strength. The supporting structure 40 is in contact with the lower sliding rail, and a certain gap is reserved between the supporting structure and the lower sliding rail. Meanwhile, to reduce the friction force between the retainer 30 and the sliding rail, the surface of the retainer 30 is spray-coated with one layer of coating with lubricating property, such as PTFE, so that additional support can be provided for the rear section of the sliding rail without affecting the sliding force of the sliding rail.

In an optional embodiment, to improve the sliding smoothness of the upper rail assembly and the lower rail assembly, a groove 41 and a protrusion may be designed on a contact part of the supporting structure 40 and the lower rail assembly 20 to simulate a steel ball structure (as shown in FIG. 6d to FIG. 6e), thereby reducing the contact surface with the lower sliding rail; furthermore, the surface is spray-coated with one layer of coating with lubricating property, such as PTFE to reduce the friction force, support the upper rail and improve the modal of the sliding rail.

In an optional embodiment, the body of the retainer 30 and the supporting structure 40 may be made of the same or different materials. For example, the body of the retainer 30 and the supporting structure 40 are made of polyamide-6 (PA6) materials, or the retainer 30 is made of the polyamide-6 material and the supporting structure 40 is made of polyformaldehyde resin (POM) or other materials with higher strength. When the body of the retainer 30 and the supporting structure 40 are made of the same PA6 material, to improve the rigidity of the extending section 43 in FIG. 6f, the extending section 43 may be internally filled with metal wires (FIG. 6g) or metal balls (FIG. 6h), the upper rail is supported at the rear end of the sliding rail, in particular, under the bumping occasion, the modal of the sliding rail can be effectively improved; meanwhile, a lubricating coating can be added on the surface of the supporting structure 40 to reduce the friction force.

In an optional embodiment, continuously referring to FIG. 6f, a guide bevel edge 42 is arranged at a rear end of the supporting structure 40. When the upper rail and the lower rail are paired, the upper rail is prevented from colliding with the extending section, and damage to the structure is avoided.

During use, firstly, the steel ball is embedded into the steel ball clamping groove of the retainer 30, then the retainer 30 is bent along the bending area 31, and the retainer 30 is assembled in the middle of the upper rail and the lower rail, so that the retainer 30 can slide in a ball groove together with the upper rail assembly and support the upper rail.

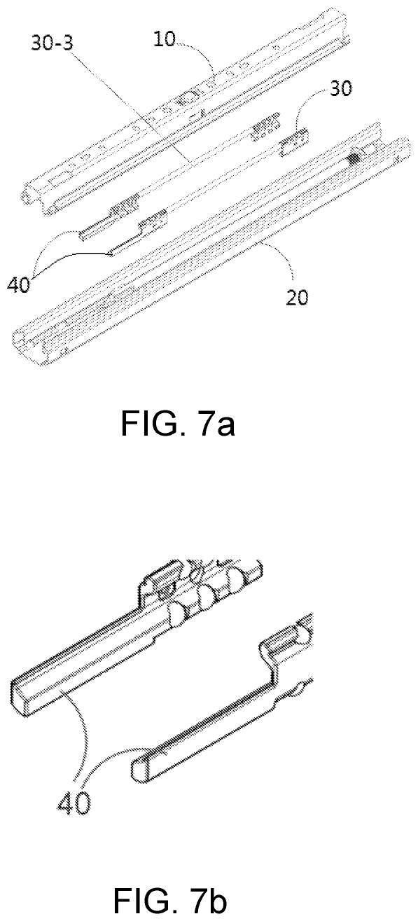

The retainer in this embodiment may adopt other forms. Referring to FIG. 7a and FIG. 7b, the middles of two ends of each retainer 30 are connected together through a straw 30-3, a supporting structure 40 is arranged at one end of the retainer 30, and the supporting structure 40 provides support for the upper rail assembly.

### Embodiment 2

This embodiment aims at the optimization of a sliding rail of a short rear retainer 30. The rear stroke of the sliding rail of the rear seat of a vehicle is generally short, so the selected retainer 30 is short. Under the working condition of the short retainer 30, when the upper sliding rail is located at a design position or a frontmost position of a comfortable stroke, the sliding rail will have a poor modal, and the fundamental reason is that a rear end of the upper sliding rail is in a suspended state and lacks support. The present invention designs an auxiliary supporting structure used in cooperation with the short retainer 30. Through cooperation between the short retainer 30 and the new structure, support is provided for an upper rail all the time, in particular, under a shaking occasion, the modal performance of the sliding rail can be effectively improved. The specific solutions are as follows:

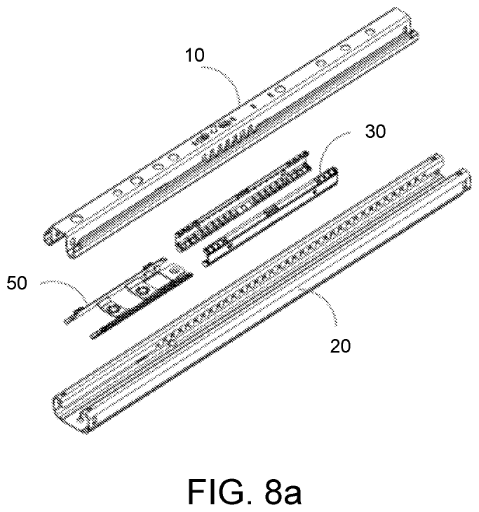

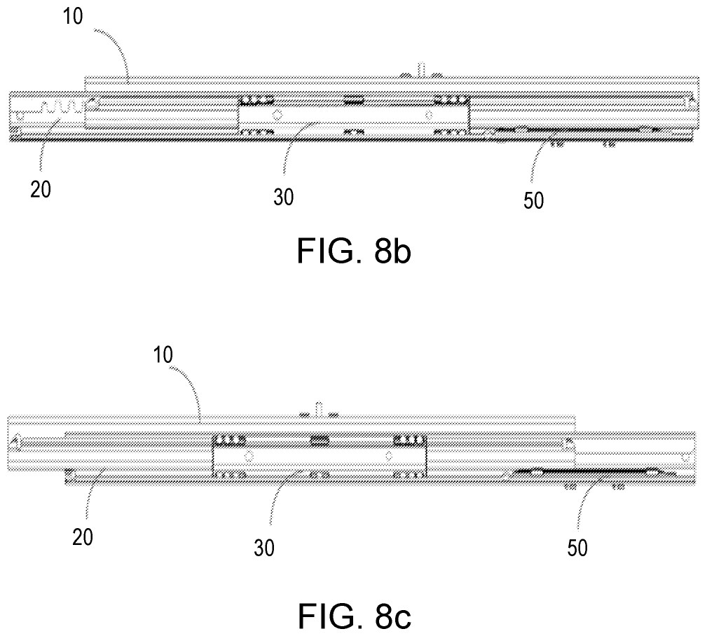

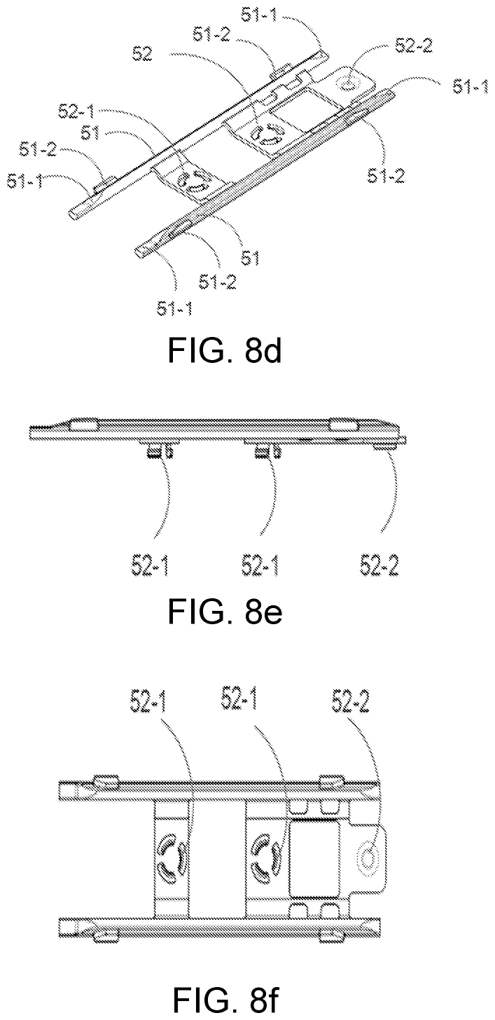

a sliding rail having an enhanced rigidity modulus includes an upper rail assembly 10, a lower rail assembly 20, and retainers 30; the upper rail assembly 10 is slidably arranged in a sliding groove of the lower rail assembly 20 through a pair of retainers 30; first raised ribs and/or steel ball clamping grooves are arranged at intervals on surfaces, in contact with the upper rail assembly 10 and the lower rail assembly 20, of the retainers 30; steel balls are mounted in the steel ball clamping grooves; a fixed supporting structure 50 is fixedly mounted at a rear end in the sliding groove; and when the upper rail assembly 10 slides backwards to the farthest stroke, the fixed supporting structure 50 provides longitudinal auxiliary support for a mid-rear section of the upper rail assembly 10, as shown in FIG. 8a to FIG. 8c.

In an optional embodiment, as shown in FIG. 8d, supporting strips 51 located in a length direction of the lower rail assembly 20 are arranged on two sides of the supporting structure; guide bevel edges are arranged on upper surfaces of two ends of the supporting strips 51; and when the upper rail moves relative to the lower rail, the upper rail can be prevented from colliding with the fixed supporting structure 50, and damage to the structure of the fixed supporting structure 50 can be avoided. Furthermore, retainer stop blocks 51-2 for limiting the sliding strokes of the retainers 30 are respectively arranged at front and rear ends of the supporting strips 51, and the retainer stop blocks 51-2 can replace retainer blocking points on the sliding rail.

In an optional embodiment, two supporting strips 51 are fixedly connected through a connecting plate 52, at least one elastic buckle 52-1 protruding downwards and in clamping connection with a bottom plate of the sliding groove is arranged on the connecting plate 52, and the fixed supporting structure 50 is fixedly mounted in a sliding rail hole of the lower rail through the elastic buckle 52-1; furthermore, at least one positioning column 52-2 protruding downwards and embedded into a positioning hole in the bottom plate of the sliding groove is arranged on the connecting plate 52, and plays a guide and positioning role during mounting.

The retainers 30 in this embodiment adopt existing design. During use, the steel balls are embedded into the steel ball clamping grooves of the retainers 30, then the retainers 30 are bent along thin sides, the retainers 30 are assembled in the middle of the upper rail and the lower rail, and the retainers 30 can slide with the upper sliding rail along a ball groove and provide support for the upper rail within the stroke range of the sliding rail.

The fixed supporting structure newly designed by the present invention is made of a POM material with high hardness and rigidity and is connected and fixed to the lower sliding rail through the elastic buckle 52-1, and the tail ends of the supporting strip 51 provide support for the upper rail at the rear section of the sliding rail; and through cooperation between the retainers 30 and the fixed supporting structure 50, support is provided for the whole upper rail, in particular, under the working condition of bumping and shaking, the modal of the sliding rail can be effectively improved.

The preferred embodiments of the present invention are described above. It should be understood that the present invention is not limited to the above specific embodiments, and devices and structures that are not described in detail should be understood to be implemented in a common manner in the art; any person skilled in the art can make many possible variations and modifications to the technical solutions of the present invention, or modify them to be equivalent examples of the variations, without departing from the scope of the technical solutions of the present invention, which will not affect the essential content of the present invention. However, any simple modification, equivalent change and modification made in accordance with the technical essence of the present invention without departing from the content of the technical solution of the present invention are still within the scope of protection of the technical solutions of the present invention.

What is claimed is:

1. A sliding rail having an enhanced rigidity modulus, comprising an upper rail assembly, a lower rail assembly, and retainers, characterized in that the upper rail assembly is slidably arranged in a sliding groove in the lower rail assembly through a pair of retainers; first raised ribs and/or steel ball clamping grooves are arranged at intervals on surfaces, in contact with the upper rail assembly and the lower rail assembly, of the retainers; a steel ball is mounted in the steel ball clamping groove;
a supporting structure extending backwards in a length direction of the retainers is arranged at a rear end of each of the retainers; and when the upper rail assembly slides backwards to the farthest stroke, the supporting structure provides longitudinal auxiliary support for a mid-rear section of the upper rail assembly, the supporting structure is in contact with the lower rail assembly, and a gap is reserved between the supporting structure and the upper rail assembly.

2. The sliding rail having an enhanced rigidity modulus according to claim 1, characterized in that
second raised ribs are arranged at intervals on a surface, in contact with the lower rail assembly, of the supporting structure; and/or
a surface of the supporting structure is spray-coated with a lubricating coating; and/or
surfaces of the retainers are spray-coated with lubricating coatings; and/or
a grease layer is arranged between the supporting structure, and the upper assemblies and lower rail assemblies.

3. The sliding rail having an enhanced rigidity modulus according to claim 2, characterized in that the lubricating coating is a polytetrafluoroethylene coating.

4. The sliding rail having an enhanced rigidity modulus according to claim 1, characterized in that the retainers are made of polyamide-6 materials, and the supporting structure is made of polyformaldehyde resin.

5. The sliding rail having an enhanced rigidity modulus according to claim 1, characterized in that the retainers and the supporting structure are made of polyamide-6 materials.

6. The sliding rail having an enhanced rigidity modulus according to claim 5, characterized in that the supporting structure is filled with metal wires or metal balls.

7. The sliding rail having an enhanced rigidity modulus according to claim 1, characterized in that a guide bevel edge is arranged at a tail end of the supporting structure.

8. A sliding rail having an enhanced rigidity modulus, comprising an upper rail assembly, a lower rail assembly, and retainers, characterized in that the upper rail assembly is slidably arranged in a sliding groove in the lower rail assembly through a pair of retainers; first raised ribs and/or steel ball clamping grooves are arranged at intervals on surfaces, in contact with the upper rail assembly and the lower rail assembly, of the retainers; a steel ball is mounted in the steel ball clamping groove;
a supporting structure is fixedly mounted at a rear end in the sliding groove; and when the upper rail assembly slides backwards to the farthest stroke, the supporting structure provides longitudinal auxiliary support for the mid-rear section of the upper rail assembly.

9. The sliding rail having an enhanced rigidity modulus according to claim 8, characterized in that
second raised ribs are arranged at intervals on a surface, in contact with the lower rail assembly, of the supporting structure; and/or
a surface of the supporting structure is spray-coated with a lubricating coating; and/or
surfaces of the retainers are spray-coated with lubricating coatings; and/or
a grease layer is arranged between the supporting structure, and the upper assemblies and lower rail assemblies.

10. The sliding rail having an enhanced rigidity modulus according to claim 9, characterized in that the lubricating coating is a polytetrafluoroethylene coating.

11. The sliding rail having an enhanced rigidity modulus according to claim 8, characterized in that the retainers are made of polyamide-6 materials, and the supporting structure is made of polyformaldehyde resin.

12. The sliding rail having an enhanced rigidity modulus according to claim 8, characterized in that the retainers and the supporting structure are made of polyamide-6 materials.

13. The sliding rail having an enhanced rigidity modulus according to claim 12, characterized in that the supporting structure is filled with metal wires or metal balls.

14. The sliding rail having an enhanced rigidity modulus according to claim 8, characterized in that supporting strips located in a length direction of the lower rail assembly are arranged on two sides of the supporting structure; guide bevel edges are arranged at two ends of each of the supporting strips; and retainer stop blocks for limiting the sliding strokes of the retainers are respectively arranged at front and rear ends of the supporting strips.

15. The sliding rail having an enhanced rigidity modulus according to claim 14, characterized in that two supporting strips are fixedly connected through a connecting plate; at least one elastic buckle protruding downwards and in clamping connection with a bottom plate of the sliding groove is arranged on the connecting plate; and/or at least one positioning column protruding downwards and embedded into a positioning hole in the bottom plate of the sliding groove is arranged on the connecting plate.
